(19) United States
(12) Patent Application Publication
(10) Pub. No.: US 2023/0012714 A1
(43) Pub. Date: Jan. 19, 2023

(54) BEVERAGE MAKER HAVING AN OUTLET DEVICE

(71) Applicant: Franke Kaffeemaschinen AG, Aarburg (CH)

(72) Inventor: Heinz VETTERLI, Wangen (CH)

(73) Assignee: Franke Kaffeemaschinen AG, Aarburg (CH)

(21) Appl. No.: 17/784,789

(22) PCT Filed: Dec. 10, 2020
(86) PCT No.: PCT/EP2020/085637

§ 371 Date: Jun. 13, 2022

(30) Foreign Application Priority Data
Dec. 18, 2019 (DE) 10 2019 134 919.2

(51) Int. Cl. A47J 31/46; A47J 31/06; A47J 31/44

(52) U.S. Cl. CPC A47J 31/467; A47J 31/0663; A47J 31/4403

(57) ABSTRACT

A beverage maker for dispensing coffee beverages includes a water heater, a brewing apparatus, which can be supplied with hot water from the water heater, and an outlet device, which is connected to the brewing apparatus via a hot-beverage line. The beverage maker also has at least one outlet head, which can be secured on the outlet device and is intended for dispensing one or more beverage components, which are guided to the outlet device via separate food lines. The outlet device has a mechanical interface in order for the outlet head to be coupled on in a sealing manner.

### TECHNICAL FIELD

The present invention relates to a beverage maker, in particular for dispensing coffee beverages, comprising a water heater, a brewing apparatus which can be supplied with hot water from the water heater, and an outlet device which is connected to the brewing apparatus via a hot-beverage line.

### BACKGROUND

Automatic coffee machines which serve for preparing and dispensing coffee-based beverages in portions are known in the prior art. In this case, the beverage is selected via a user interface. After selecting a beverage variant, a coffee beverage is prepared according to the user specifications and dispensed to a beverage outlet by means of an integrated brewing apparatus. Outlets for further beverage components such as milk, milk foam or flavorings are frequently provided in addition to the aforementioned hot-beverage outlet. In this case, the outlets may be grouped together to form an outlet head which is fixedly arranged on the automatic coffee machine.

In addition, so-called portafilter machines are known in the prior art in which, instead of an outlet head, a portafilter is sealingly fastened to an outlet attached thereto. The portafilter is filled by hand with coffee grounds, fastened to the portafilter machine and pressurized with hot water thereby until a predetermined quantity of hot water has passed through the coffee filter contained in the portafilter and the coffee grounds cake contained in the coffee filter. Further beverage additives are added manually to the coffee beverage by the barista.

Finally, hybrid systems are also known, in which a portafilter is also used but this is automatically filled with ground coffee grounds via an integrated coffee grinder. Such a hybrid coffee machine is disclosed, for example, in WO 2010 085850 A1.

### SUMMARY

The object of the invention is to specify a beverage maker which combines the advantages of an automatic coffee machine and the advantages of a portafilter machine regarding exchangeability and simple cleaning relative to the outlet head.

The object is achieved by a beverage maker having one or more of the features described herein. Advantageous embodiments are found below and in the claims.

In a beverage maker of the type mentioned in the introduction, according to the invention it is provided that the beverage maker comprises at least one outlet head which can be secured on the outlet device and is intended for dispensing one or more beverage components which are guided to the outlet device via separate food lines, and the outlet device has a mechanical interface in order for the outlet head to be coupled on in a sealing manner.

In this case, the outlet head comprises the outlet for a freshly brewed hot beverage, such as coffee, and optionally further outlets for other beverage components, such as milk, milk foam or flavorings. The mechanical interface for coupling on the outlet head permits simple removal for cleaning purposes or for exchanging the outlet head. This outlet head may be configured, in particular, with an external shape which is similar to a portafilter, the upper face thereof however being formed by a sealing surface which is provided with connection openings but which is otherwise closed. The design of the outlet head in the form of a portafilter permits a simple and intuitive operation and provides the impression and appeal of a professional barista machine.

In a preferred embodiment, the mechanical interface has a linear guide for pushing in the outlet head. The outlet head may thus be pushed into the guide, for example, from the front and pulled out for exchange or cleaning in a simple manner.

Alternatively or additionally, the mechanical interface has an operating lever which is configured to press the outlet head via a pressing mechanism against a sealing surface of the outlet device provided with connection points. Via the operating lever, therefore, the outlet head may be coupled sealingly against the outlet device or decoupled therefrom. Via the connection points, a fluidic connection is made between the outlets arranged on the outlet head and the food lines guided to the outlet device. The coupling by pressing against a sealing surface permits a simple and operationally reliable coupling between the outlet head and the outlet device. A particularly simple operation results, in conjunction with an aforementioned linear guide, by inserting the outlet head into the guide and subsequently coupling and locking the outlet head relative to the outlet device by means of the operating lever.

A motor may also be provided as an alternative to a pressing mechanism, said motor moving the outlet head against the outlet device, when actuating an operating element such as an operating lever, in order to press this outlet head against the sealing surface of the outlet device.

In a further embodiment, the mechanical interface may also have a different fastening, in particular in the form of a rotary fastening such as a bayonet closure, instead of a linear guide and a pressing mechanism.

In the context of the present invention, in particular, it may be provided that the mechanical interface has a plurality of connection openings for different beverage components, said connection openings communicating with the food lines and the connecting head being sealingly coupled thereagainst. The outlet head in this case may have, in particular, a sealing surface with corresponding openings for a partial number—or even all—of the connection openings, wherein the sealing surface in the coupled-on state of the outlet head closes the remaining connection openings, i.e. the connection openings not being used by the outlet head. Thus it may be provided, in particular, that not all of the beverage components provided by the outlet device are able to be dispensed on one connecting head. Thus a preselection of beverage variants which are able to be dispensed is carried out by selecting a connecting head coupled to the outlet device. For example, separate outlet heads may be provided for dispensing espresso into one cup (single spout), for dispensing espresso into two cups at the same time (double spout), or for dispensing cappuccino and latte macchiato.

The individual connection openings on the outlet device are preferably provided in each case with a seat. This seal provides a seal relative to the coupled-on sealing surface of the connecting head or closes the relevant connection opening when this is not being used by the outlet head.

In a preferred embodiment, the outlet device has a heater for warming up the outlet device and the outlet head coupled thereon. Thus, hot beverages are dispensed via the preheated outlet device and the preheated outlet head, so that these hot beverages are not cooled on their path into a drinking vessel. In this case, a thermal coupling of the outlet head may take place, in particular, via the sealing surface thereof which may be designed in metal, for example in cast aluminum.

Since the present invention permits a simple exchange of the connecting heads, in a further preferred embodiment it may be provided that the outlet head is provided with an identifier which identifies beverage types which may be dispensed via the outlet head, and the outlet device has a reader for reading the identifier. The identifier may be, in particular, an identifier which may be read in a contactless manner, such as an RFID tag, NFC chip or the like. Similarly, it is within the scope of the present invention to provide an optically or magnetically readable code as an identifier on the outlet head. Moreover, a mechanical coding might also be possible, for example by pins or projections of different lengths and a mechanical scanning of the pin lengths on the outlet device, and is encompassed within the scope of the invention.

Within the scope of the present invention it is provided that the outlet head may be exchanged. In particular, it is possible to provide different outlet heads for different beverages or sets of beverages, said outlet heads being able to be selectively coupled onto the outlet device. Via the identifier of the different outlet heads and the reader arranged on the outlet device it is possible to identify automatically the type of currently coupled-on outlet head on the beverage maker and only to provide and to enable such beverages or beverage variants for selection which may be dispensed with the currently coupled-on outlet head.

Preferably, to this end the beverage maker comprises a controller and a user interface connected thereto in terms of signal technology, in particular a graphical user interface. Different beverages or beverage variants may be selected via the user interface. The controller is configured in this case to initiate an automatic preparation and dispensing of a selected beverage or a selected beverage variant by the beverage maker and correspondingly to activate the beverage maker. The controller cooperates with the reader in order to offer only those beverages or beverage variants for selection which may be dispensed via the coupled-on outlet head, via the graphical user interface as a function of the identifier read by the reader. Thus, different outlet heads may be used for different beverages or sets of beverages, wherein a preselection of possible beverages is controlled via an automatic recognition of the currently used outlet head.

### BRIEF DESCRIPTION OF THE DRAWINGS

Further advantages and properties of the present invention emerge from the following description of exemplary embodiments with reference to the figures, in which:

FIG. 1 shows a view of a beverage maker with the outlet device and the coupled-on outlet head,

FIG. 2 shows the beverage maker according to FIG. 1 with the outlet head removed,

FIG. 3A shows a view of the beverage maker with the removed outlet head in perspective from below,

FIG. 3B shows a detailed view of the outlet device of FIG. 3A,

FIG. 4 shows the beverage maker with three alternatively useable outlet heads, and

FIG. 5 shows a water flow diagram of a beverage maker.

### DETAILED DESCRIPTION

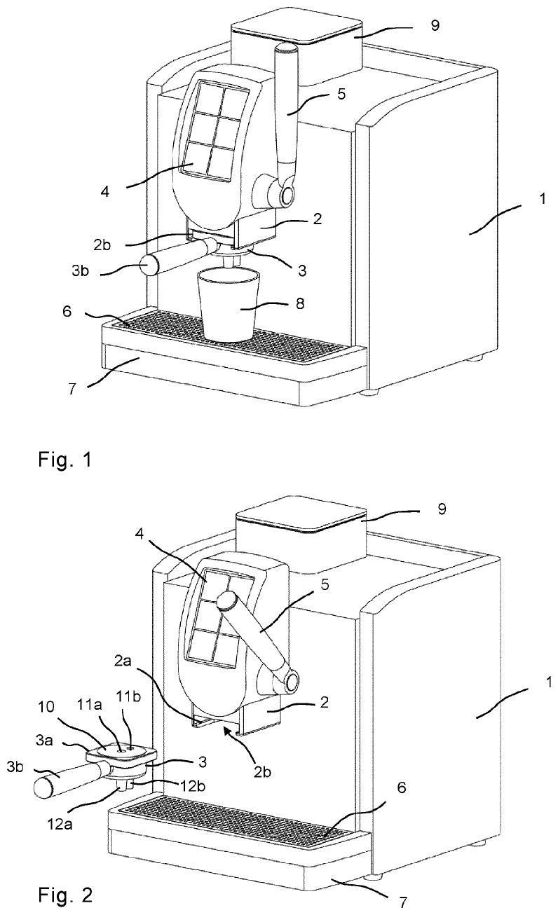

A beverage maker in the form of an automatic coffee machine is shown in FIG. 1. An outlet device 2 with a receiver for an outlet head 3 is located on the front face of the automatic coffee machine. A graphical user interface 4 in the form of a touch-sensitive display is arranged above the outlet device 2. An operating lever 5 which serves for locking or unlocking the outlet head received in the receiver of the outlet opening 2 is located at the side thereof. Below the outlet device 2 is a collection tray 7 with a drip grid 6. By way of example, a drinking vessel 8 is positioned on the drip grid 6 below the outlet head 3, a hot beverage to be dispensed by the automatic coffee machine 1 being filled into said drinking vessel.

A storage container 9 for coffee beans is shown in the upper region of the automatic coffee machine 1. The automatic coffee machine has an integrated grinder by which coffee beans are ground in portions and filled into an integrated brewing apparatus for preparing a coffee beverage.

The function of the beverage maker shown corresponds to the conventional automatic coffee machine. When a beverage variant which is shown in the form of a pictogram on the touch-sensitive display 4 is selected, and optionally a corresponding start symbol is actuated, an automatic preparation and dispensing of the selected beverage takes place. In this case, only those beverage variants which may be dispensed with the inserted outlet head 3 may be selected via the graphical user interface 4.

In FIG. 2 the automatic coffee machine 1 is shown with the outlet head 3 removed. To this end, the operating lever 5 is pivoted to the front in order to unlock the outlet head 3 and the outlet head 3 is pulled out to the front from the guide 2a of the outlet device 2.

The outlet head 3 has a carrier 3a which is shaped in a manner similar to a conventional portafilter and is provided with a handle 3b. A circular sealing surface 10 is configured on the upper face of the carrier 3a, in the exemplary embodiment shown two openings 11a, 11b, which correspond to outlets 12a, 12b on the lower face of the outlet head, being located therein. Via these openings 11a, 11b and associated outlets 12a, 12b beverage components may be dispensed via the outlet device.

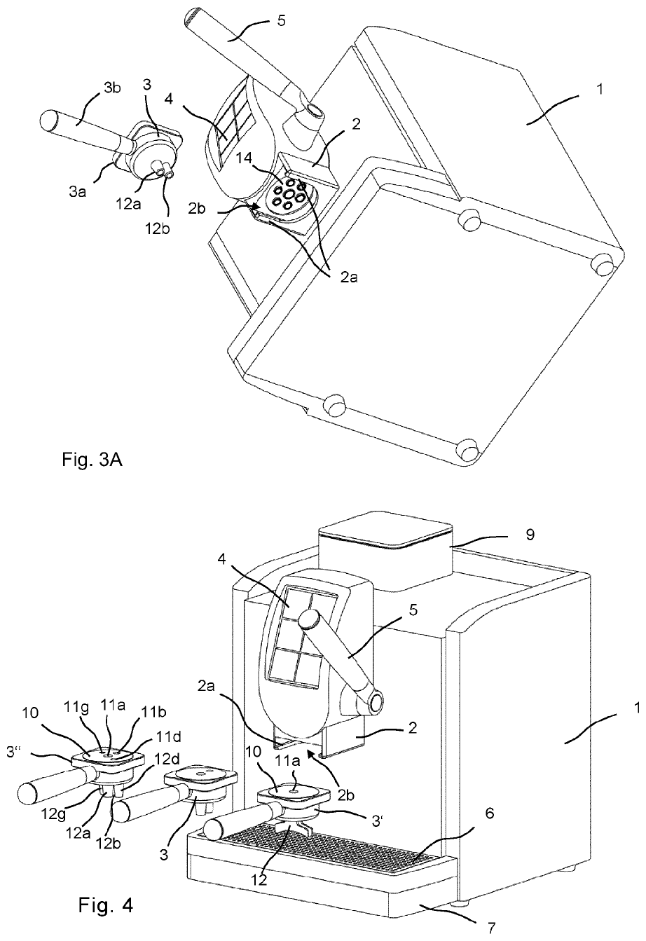

In FIG. 3A the automatic coffee machine is shown in perspective from below. In this case, it is possible to observe from below into the receiver 2b of the outlet device 2 in which the outlet head may be inserted. The two projections protruding inwardly to the side on the lower face of the outlet device 2 form the linear guide 2a for the outlet head 3. A total of seven outlet openings 13a to 13g for different beverage components which may be dispensed via the outlet device 2 are located on the upper face of the receiver 2b, said beverage openings being shown enlarged in the detailed view of FIG. 3B. A sealing surface 14, which corresponds to the sealing surface 10 of the outlet head 3, is configured around the outlet openings 13a to 13g. Moreover, in each case annular seals, which seal the outlet openings 13a to 13g relative to the sealing surface 10 of an inserted outlet head, are located around the outlet openings 13a to 13g. The central outlet opening 13a serves for dispensing freshly brewed coffee; the outlet opening 13b for milk and milk foam, and the remaining outlet openings 13c-13g for further beverage additives.

The function of the operating lever 5 is to press an outlet head 3 inserted into the receiver 2b via a corresponding pressing mechanism, for example a lever mechanism or a toothed rack with a pinion, against the sealing surface 14 of the outlet device 2 and thus to couple the outlet head 3 sealingly onto the outlet device and the outlet openings 13a to 13g thereof. Alternatively, a motor-operated drive unit may also be provided, said drive unit when actuated—namely via an operating lever 5 as shown in the figures—pressing the outlet head against the sealing surface 14 of the outlet device 2. Naturally, the actuating direction shown in the figures may be reversed, i.e. the outlet head is locked in the vertical position and is locked in the position pivoted to the front.

In the exemplary embodiment, only two of the outlet openings 13a to 13g, namely the outlet openings 13a and 13b, are connected to the outlets 12a, 12b via the associated openings 11a, 11b in the sealing surface 10 of the outlet head. The remaining outlet openings 13c to 13g are closed in a fluid-tight manner by the sealing surface 10 of the outlet head 3. Therefore, it is not possible for dispensing to take place via the outlet openings 13c to 13g thus closed, such that the associated beverage components may not be dispensed and are not available when using the outlet head 3.

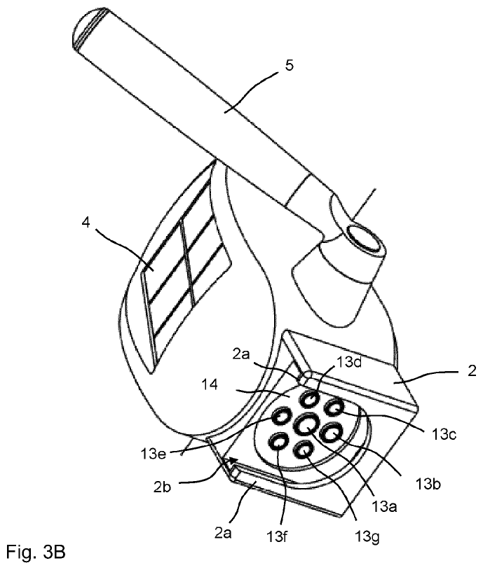

In FIG. 4 the automatic coffee machine 1 is shown with three alternately usable outlet heads 3, 3′, 3″. In the case of the outlet head 3′, only one opening 11a is present in the sealing surface 10. This leads to a double spout 12 for two espresso cups. Thus, with the outlet head 3′ an espresso may be drawn off and dispensed into two cups at the same time. On the other hand, other selection options, such as milk or beverages containing milk foam, are blocked on the user interface 4 and the corresponding pictograms are either not shown at all or greyed out.

In the case of the outlet head 3″, four outlet openings 11a, 11b, 11d and 11g which correspond to the corresponding outlets 12a, 12b, 12d and 12g are present by way of example. Accordingly, a total of four different beverage components may be dispensed and mixed using this outlet head. For example, coffee beverages may be dispensed with milk foam and additional liquid flavorings.

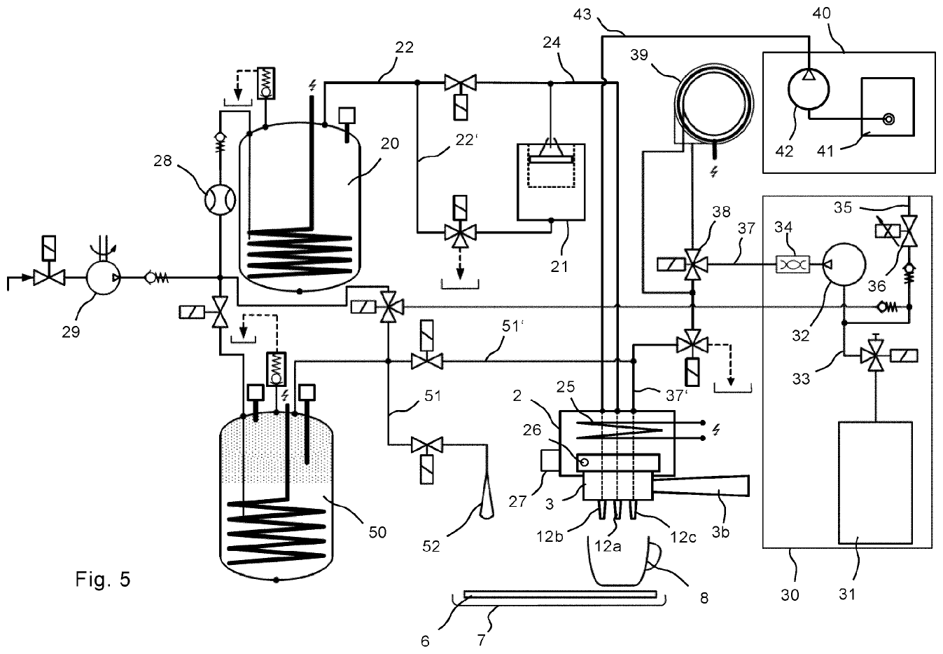

In FIG. 5 a hydraulic circuit which may be installed in the automatic coffee machine is schematically shown in the form of a water flow diagram. The circuit has a water heater 20 which is connected via a line 22, 22′ to a brewing apparatus 21. On the outlet side the brewing apparatus 21 is connected via the outlet line 24 to an outlet device 2. The brewing apparatus is a conventional brewing unit of an automatic coffee machine. A brewing unit which may be used in the context of the present invention is described, for example, in EP 2561778 A1 which is incorporated by reference in its entirety in order to avoid unnecessary repetition. The water quantity conducted through the brewing chamber is metered via a flowmeter 28. The hot water from the water heater 20 is conveyed via a water pump 29 connected on the feed side.

A milk system is also shown in the water flow diagram. This milk system comprises a refrigerator 30 with a milk container 31, a milk pump 32, which is connected to the milk container 31 via an extraction line, and a counter-pressure element 34 which is connected to the milk pump 32 on the pressure side and which is designed in this case as a helical mixer. Alternatively, it is also possible to use a simple diaphragm or a pressurized hose with a reduced internal diameter as the counter-pressure element 34. An air intake line 35 with an air valve 36 also leads into the suction line 33. The air valve 36 is configured here as a solenoid valve which is activated in a clocked manner, i.e. intermittently opening and closing. The counter-pressure element 34 and air valve 36 serve for foaming milk in a manner known per se. A corresponding milk system is disclosed in EP 3 021 037 A1 which is incorporated by reference in its entirety in order to avoid unnecessary repetition.

A milk line 37 leads from the pressure increasing element 34 to a changeover valve 38 by which the milk or milk foam conveyed by the milk pump 32 may be selectively conducted via a thermoblock 39 or directly to the outlet device 2. Correspondingly, either warm or cold milk (air valve closed) or warm or cold milk foam (air valve opened and closed in a clocked manner) may be dispensed via the milk system and the outlet device 2.

Finally, a further device 40 is shown in the water flow diagram for dispensing a further beverage component, for example a syrupy flavoring. In this case, the device 40 comprises a storage container 41 for the relevant flavoring and a metering pump 42, the flavoring being conveyed thereby via a food line 43 to the outlet device 2. The device 40 in this case is shown only by way of example. It is possible to provide further identical or similar devices for further beverage components which are connected to the outlet device via separate food lines. A corresponding syrup station, which may be used in the context of the present invention, is disclosed in EP 2 030 538 which is incorporated by reference in its entirety in order to avoid unnecessary repetition.

The milk refrigerator 30 and the syrup station 40 are typically designed as separate appliances which are positioned as an add-on appliance adjacent to the beverage maker or installed below a counter and are connected to the beverage maker and the outlet device 2 via externally supplied food lines.

Thus, in the exemplary embodiment shown the outlet device 2 has three beverage supply lines, namely the hot-beverage line 24, the line for milk or milk foam 37′ and the food line 43 for liquid flavorings. An outlet head 3 of the above-described design is coupled onto the outlet device 2. This outlet head has three outlets 12a, 12b, 12c which are fluidically connected to the aforementioned food lines 24, 37′, 43 via the outlet device 2.

The outlet device 2 also has a heater 25, both the outlet device 2 and the outlet head 3 coupled thereon being able to be preheated thereby. This serves to avoid the situation where the hot beverages to be dispensed are cooled during the dispensing process. In this case, the outlet head 3 is heated via the contact surface between the outlet head 3 and the outlet device 2.

In FIG. 5 it is also schematically shown that an RFID tag 26, which may be read by an RFID reader 27 arranged on the outlet device, is attached to the outlet head 3. The outlet head and the beverage components able to be dispensed thereby may be identified via the RFID tag 26, so that via a corresponding controller of the beverage maker only those beverages or beverage variants which may be dispensed by the relevant outlet head 3 are enabled and displayed for selection at the user interface thereof. By changing an outlet head, therefore, other beverage variants may be provided.

Finally, a second water heater and steam generator 50 is shown in the water flow diagram. This provides hot water for flushing and cleaning purposes as well as steam. Steam may be dispensed, for example, via a steam line 51 and a steam lance 52 of conventional construction. In the beverage maker shown in FIGS. 1 to 4, such a steam lance is not shown for the sake of improved clarity but could be arranged in the known manner to the side of the outlet device 2.

Moreover, the steam may be conducted via a steam line 51′ to the outlet device 2 where it may be used, for example, for reheating milk or milk foam. The flushing lines and flushing or drainage valves, also shown for the sake of completeness, are known generally to the person skilled in the art and therefore do not need to be described in more detail here. The function of the flushing lines and flushing or drainage valves is described in more detail, for example, in EP 2 583 596 A1, which is incorporated by reference in its entirety in order to avoid unnecessary repetition.

1. A beverage maker, comprising;
a water heater (20),
a brewing apparatus (21) which is suppliable with hot water from the water heater (20),
an outlet device (2) which is connected to the brewing apparatus (21) via a hot-beverage line (24),
at least one outlet head (3), which is securable on the outlet device (2) and is configured for dispensing one or more beverage components which are guided to the outlet device (2) via separate food lines (24, 37′, 43),
the outlet device (2) has a mechanical interface (2a, 2b, 5) via which the outlet head (3, 3′, 3″) is sealingly coupled thereon, and
the mechanical interface has a plurality of connection points (13a-13g) for different beverage components, the outlet head (3, 3′, 3″) being sealingly coupled thereagainst, and the outlet head (3, 3′, 3″) has a sealing surface (10) with corresponding openings (11a, 11b, 11d, 11g) for a partial number of the connection points (13a-13g), and the sealing surface (10) in a coupled-on state of the outlet head (3, 3′, 3″) closes remaining ones of the connection openings (11c, 11e, 11f) in a fluid-tight manner.

2. The beverage maker as claimed in claim 1, wherein the mechanical interface comprises a linear guide (2a) configured for pushing in the outlet head (3, 3′, 3″).

3. The beverage maker as claimed in claim 2, wherein the mechanical interface further comprises an operating lever (5) which is configured to press the outlet head (3, 3′, 3″) via a pressing mechanism against a sealing surface (14) of the outlet device (2) provided with connection points (13a-13g).

4. The beverage maker as claimed in claim 1, wherein the mechanical interface comprises a motor which is actuated via an operating element (5) and which, upon actuation, is configured to press the outlet head (3, 3′, 3″) against a sealing surface (14) of the outlet device (2) provided with connection points (13a-13g).

5. The beverage maker as claimed in claim 1, wherein the mechanical interface comprises a rotary fastening configured for coupling on the outlet head (3, 3′, 3″).

6. (canceled)

7. The beverage maker as claimed in claim 1, wherein the individual connection points (13a-13g) are each provided with a seal.

8. The beverage maker as claimed in claim 1, wherein the outlet device (2) has a heater (25) configured for warming up the outlet device (2) and the outlet head (3, 3′, 3″) coupled thereon.

9. The beverage maker as claimed in claim 1, wherein the outlet head (3, 3′, 3″) is provided with an identifier (26) which is readable in a contactless manner and which identifies beverage types which are dispensable via the outlet head (3, 3′, 3″), and the outlet device (2) has a reader (27) for reading the identifier (26).

10. The beverage maker as claimed in claim 9, further comprising a controller and a user interface (4) connected for signal transmission to the controller, via which different beverages or beverage variants are selectable, the controller is configured to initiate an automatic dispensing of a selected beverage or a selected beverage variant by the beverage maker, and the controller cooperates with the reader (27) in order to offer only those beverages or beverage variants for selection which are dispensable via the coupled-on outlet head (3, 3′, 3″), via the graphical user interface (4) as a function of the identifier (26) read by the reader (27).

11. The beverage maker as claimed in claim 1, wherein the outlet head (3, 3′, 3″) is configured as a portafilter, an upper face thereof being formed by a sealing surface (10) which is provided with connection openings (11a, 11b, 11d, 11g) and which is otherwise closed.

12. The beverage maker as claimed in claim 1, further comprising a plurality of the outlet heads (3, 3′, 3″) for different beverages or sets of beverages which are alternately couplable onto the outlet device (2).

13. The beverage maker as claimed in claim 5, wherein the rotary fastening comprises a bayonet closure.

14. The beverage maker as claimed in claim 9, wherein the identifier comprises an RFID tag.
